(19) United States
(12) Patent Application Publication
(10) Pub. No.: US 2025/0017798 A1
(43) Pub. Date: Jan. 16, 2025

(54) LOW-PROFILE BEDPANS

(71) Applicant: Maciej Witkos, Carlsbad, CA (US)

(72) Inventor: Maciej Witkos, Carlsbad, CA (US)

(21) Appl. No.: 18/771,704

(22) Filed: Jul. 12, 2024

Related U.S. Application Data
(60) Provisional application No. 63/513,485, filed on Jul. 13, 2023.

(51) Int. Cl. A61G 9/00

(52) U.S. Cl. CPC A61G 9/003; A61G 2200/327

(57) ABSTRACT

A bedpan having a housing including a chamber, a top portion including an opening to the chamber and having an edge, a proximal surface including an apron surrounding the opening, the apron extending from an edge of the proximal surface to the edge of the opening, and a rise portion of the apron that is vertically higher than the rest of the apron. The bedpan has a bottom portion including a distal surface opposite the proximal surface, and a distal edge of the distal surface, the chamber positioned interior to the housing, the side walls of the chamber being interior to the side wall such that there is space between the walls of the chamber and the side wall. The bedpan has handles disposed on the corners of the housing.

### TECHNICAL FIELD

The present invention relates to innovative structure of a bedpan. More particularly, the present application describes a low-profile bedpan structured with handles disposed in at least one corner for ease of lateral placement under a patient and a rise section for effectively capturing material from a patient.

### SUMMARY

Certain aspects of a low-profile bedpan are defined by the independent claims. The dependent claims concern optional features of some embodiments of such bedpans. Accordingly, the systems and devices described herein each have several aspects, no single one of which is solely responsible for its desirable attributes. Without limiting the scope of this disclosure, several non-limiting features will now be briefly described.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

One innovation includes a bedpan comprising a housing including a chamber for holding urine and feces, the chamber having walls and a bottom surface. The chamber can comprise a top portion including an opening to the chamber, the opening having an edge, wherein the edge includes a circumferential portion. The top portion can include a proximal surface including an apron surrounding the opening, the apron extending from an edge of the proximal surface to the edge of the opening. an angled side wall surrounding the apron. The top portion can include a rise portion on the apron, the rise portion being vertically higher than another portion of the apron. The chamber can comprise a bottom portion including a distal surface opposite the proximal surface. The bottom portion can include a distal edge of the distal surface, the chamber positioned between the proximal surface and the distal surface, the side walls of the chamber being interior to the side wall, the side wall angled outward as it extends from the circumferential edge of the proximal surface towards the distal edge of the distal surface. The chamber can comprise a handle disposed in a corner of the housing.

Any of the disclosed bedpans can have one or more additional features. In some embodiments, the handle is formed integral to the housing. In some embodiments, the bedpan further comprises four handles disposed in each of four corners of the housing, the four handles formed integral to the housing. In some embodiments, a first two handles of the four handles include apertures having a first longitudinal axis, wherein a second two handles of the four handles include apertures having a second longitudinal axis, wherein the first and second axis are aligned, with respect to each other, at an angle A that is 90° plus or minus 30°. In some embodiments, a first two handles of the four handles are on a first side of the housing and the second two handles of the four handles are on a second side of the housing, and the first side of the housing is adjacent to the second side of the housing. In some embodiments, the apron is sloped downward towards the distal surface as it extends from the edge of the proximal surface to the edge of the opening.

In some embodiments, the opening is generally ovoid in shape. In some embodiments, the housing further comprises at least one support between an interior surface of the top portion and an interior surface of the bottom portion. In some embodiments, the housing further comprises a plurality of supports arranged around the chamber. In some embodiments, the top portion and the bottom portion are operable to be separated. In some embodiments, the top portion is configured to be stacked on another top portion when the top portion and the bottom portion are separated. In some embodiments, the bottom portion is configured to be stacked on another bottom portion when the top portion and the bottom portion are separated.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a top, angled perspective view illustrating a first example of a bedpan illustrating various structural and functional aspects of some embodiments.

FIGS. 2A and 2B are side views illustrating the first example of the bedpan, illustrating various structural and functional aspects of some embodiments.

FIG. 3 is a top view illustrating the first example of the bedpan, illustrating various structural and functional aspects of some embodiments.

FIG. 4 is a side view illustrating the first example of the bedpan, illustrating various structural and functional aspects of some embodiments.

FIG. 5 is an exploded angled perspective view illustrating the first example of the bedpan, illustrating various structural and functional aspects of some embodiments, such as the top and bottom portions separated.

FIGS. 6A and 6B are top, angled perspective views illustrating a top portion of a first example of a bedpan illustrating various structural and functional aspects of some embodiments.

FIG. 7 is a side view illustrating a top portion of a first example of a bedpan illustrating various structural and functional aspects of some embodiments.

FIGS. 8A and 8B are side views illustrating a top portion of a first example of a bedpan illustrating various structural and functional aspects of some embodiments.

FIG. 9 is a top view illustrating a top portion of a first example of a bedpan illustrating various structural and functional aspects of some embodiments.

FIGS. 10A and 10B are top, angled perspective views illustrating a bottom portion of a first example of a bedpan illustrating various structural and functional aspects of some embodiments.

FIG. 11 is a side view illustrating a bottom portion of a first example of a bedpan illustrating various structural and functional aspects of some embodiments.

FIGS. 12A and 12B are perspective views illustrating a bottom portion of a first example of a bedpan illustrating various structural and functional aspects of some embodiments.

FIG. 13 is a top perspective view illustrating a bottom portion of a first example of a bedpan illustrating various structural and functional aspects of some embodiments.

FIG. 14 is a top view illustrating a top portion of a first example of a bedpan illustrating various structural and functional aspects of some embodiments.

FIGS. 15A and 15B are side views illustrating a top portion of a first example of a bedpan illustrating various structural and functional aspects of some embodiments.

FIG. 16 is a top view illustrating a bottom portion of a first example of a bedpan illustrating various structural and functional aspects of some embodiments.

FIGS. 17A and 17B are side views illustrating a bottom portion of a first example of a bedpan illustrating various structural and functional aspects of some embodiments.

### DETAILED DESCRIPTION

### Overview

This application relates to innovations for a bedpan that includes structural features that address several clinical problems. Overall, it allows for greater patient safety and comfort, easier for staff to use with a decreased risk of biohazard exposure, and improved satisfaction for health systems. Urination and defecation are essential for human well being and all persons need to be able to execute these functions. A bedpan is one of the oldest medical devices that helps patients during urination and defecation, and they have been used in hospitals and other medical and patient care facilities for many decades. A bedpan typically includes a reservoir (or chamber) for the excretion of urine and feces by a person. Usually a person (patient) that requires a bedpan is immobile or nearly so, and lacks the ability to move fully or has sustained an injury where movement causes pain. The bedpan is usually placed under a portion of a patient by a healthcare provider such as a nurse, nurse assistant, technician, EMT or physician. At times, the bedpan is placed for use by the patient. Placing the bedpan requires moving the patient to various positions or having the patient assist by moving themselves. The average healthy person has a bowel movement about once per day. However, a patient may have a bowel movement up to three times a day (or more), or as infrequent as one bowel movement per three days. The average healthy person urinates in about 21 seconds an average of 220 ml, and defecates for an average 10 minutes, with an average volume of 200-400 grams of feces per movement. Thus is some cases, a patient needs to have a bedpan positioned for use frequently and for longer periods of time.

Patients are not healthy by definition and may urinate/defecate outside of normal time and frequency ranges. This can be caused by their disease/injury or as a side effect of medical care/medications. For example, patients with benign prostatic hyperplasia (BPH) might require much longer to fully void their bladder, or patients who are infected with C. difficile bacteria, can defecate as often as every three minutes in large copious amounts. Therefore, patients can at times be on a bedpan for an extended period (over 10 minutes).

Bedpans require that the volume of the space be sufficiently large enough to contain feces and urine. As such, bedpans have a minimum certain height if the fecal or urine is not to contaminate the cutaneous surfaces (skin) of the patient and cause injury. In addition, the bedpan should be able to withstand the weight of the patient. The average weight of patients has increased dramatically in the last 40 years. The average male now weighs 199.8 lbs (90.6 kg) and average female 170.8 lbs (77.5 kg). The larger weights of patients require more structurally sound bedpans. As a patient's weight increases, a larger contact surface area on the top of the bedpan is desired to reduce pressure, however, typical bedpans lack in area, and some even have almost no top contact surface area.

In addition, given the highly infectious nature of Clostridium difficile bacteria and Norwalk virus etc., bedpans are now predominantly disposable or have the option to have a bedpan liner. There are growing calls to use biodegradable disposable bedpans, currently structurally these are unable to handle large weights. Surprisingly, most bedpans are not configured to sufficiently contain feces and fluid that have been deposited therein when the bedpan is moved. For example, many bedpans have at least one outside wall having approximately a 90-degree angle, and sometimes the outside walls on all sides are at approximately a 90 degree angle, which causes a splash when the bedpan is removed from underneath the patient and otherwise moved. Because of these inadequate designs, spillage often occurs when the bedpan is pulled from underneath a patient when it becomes stuck, usually due to patient girth/weight.

There are many bedpans being used today. For example, some bedpans, which are used because of case of placement have very small contact surface areas. Thus, these can be uncomfortable for patients and increases the probability of cutaneous injury from prolonged placement. In addition, they can only be placed from the inferior/bottom of the patient, with the patients' legs at least somewhat externally rotated. Bedpans with large surface areas are bulky and difficult to place. These are very difficult to place under a patient as they require that the patient be moved and angled sufficiently to be able to place the bedpan correctly. This can also be extremely painful for patients with lumbar/thoracic spine or hip/femur fractures. No available bedpans are structured to address all the needs of a patient and/or a medical provider. For example, there are no bedpans designed for case of placement laterally (from the side of the patient). There are no bedpans designed to allow them to be easily placed from the bottom or side or a patient. There are no bedpans having an ultra-low profile and are configured with multi-side slopes for ease of placement and reduce effort needed by provider or patient. There are no bedpans designed to reduce splashing with sloped or covered walls from all sides. The bedpans disclosed herein are configured to have address these deficiencies and have additional advantages. For example, the bedpans are structures similar to a toilet seat and are designed for patient comfort, especially when they are used for an extended period of time. Also, the disclosed embodiments provide a splash-less chamber having a greater volume than the bedpan housing opening, which reduces splashing while providing an increased chamber volume.

Embodiments of the low-profile bedpans solve at least several of these clinical problems. Overall, it allows for greater patient safety and comfort, easier for staff to use with a decreased risk of biohazard exposure, and improved satisfaction for health systems.

Embodiments of the low-profile bedpans disclosed herein can be placed underneath a patient laterally, solving the problem of bedpan placement in patients necessitating such placement. The sloped sides of the bedpan decrease the force necessary to push it between the patient and bed. Patients are heavier, increasing the physical work necessary for correct placement. In various embodiments, there is a slight upward slope of the bottom (or offset of the bottom surface) to prevent the lower side of the bedpan from catching on bed sheets. Embodiments can include four ergonomic handles, incorporated in the housing of the bedpan, allowing for controlled lateral or inferior/bottom placement. Other configurations of the handles are possible. In some embodiments, the bedpan includes only one handle which may make it less expensive to manufacture. In some embodiments, the bedpan has a handle on each side. In an example, the bedpan has a rectangular shape and includes an integrated handle on each of its four corners. Embodiments of the bedpan are designed to be similar to a toilet seat, to maintain patient comfort. This should allow for improved patient urination and defecation, as the concept of using a bedpan is uncomfortable enough. The bedpan is designed to maximize its surface area of the bedpan against a patient's skin. A large surface area decreases the pressure on the sacral, buttock area to reduce the probability of iatrogenic pressure injury. In addition, embodiments of the bedpan are designed to reduce any hard angle contact between patient and product. These design features decrease the probability of iatrogenic injury. In various embodiments, the bedpan can include one or more internal columns or supports (“supports”) positioned in the interior chamber of the bedpan or around the outside of the chamber, between the top surface of the bedpan and the bottom surface of the bedpan. The supports can be coupled to the top portion and/or the bottom portion of the bedpan. The supports allow the bedpan to support a greater weight on the top portion without deforming or breaking. In some embodiments, the bedpan includes a rise portion of the apron that is vertically higher than another portion of the apron. Advantageously, the rise portion can capture material that could otherwise miss the bedpan.

### LIST OF CERTAIN COMPONENTS

The following is a list of certain components that are described and enumerated in this disclosure in reference to the above-listed figures. However, any aspect of the devices illustrated in the figures, whether or not named out separately herein, can form a portion of various embodiments of the invention and may provide basis for claim limitation relating to such aspects, with or without additional description. The enumerated components include:

| | |
|---|---|
| 100 | bedpan |
| 102 | housing |
| 108 | opening |
| 114 | top portion |
| 116 | bottom portion |
| 118 | edge around opening |
| 126 | handle |
| 126a | first handle |
| 126b | second handle |
| 126c | third handle |
| 126d | fourth handle |
| 130 | apron |
| 132 | rise portion |
| 134 | chamber floor |

### Illustrative Embodiments

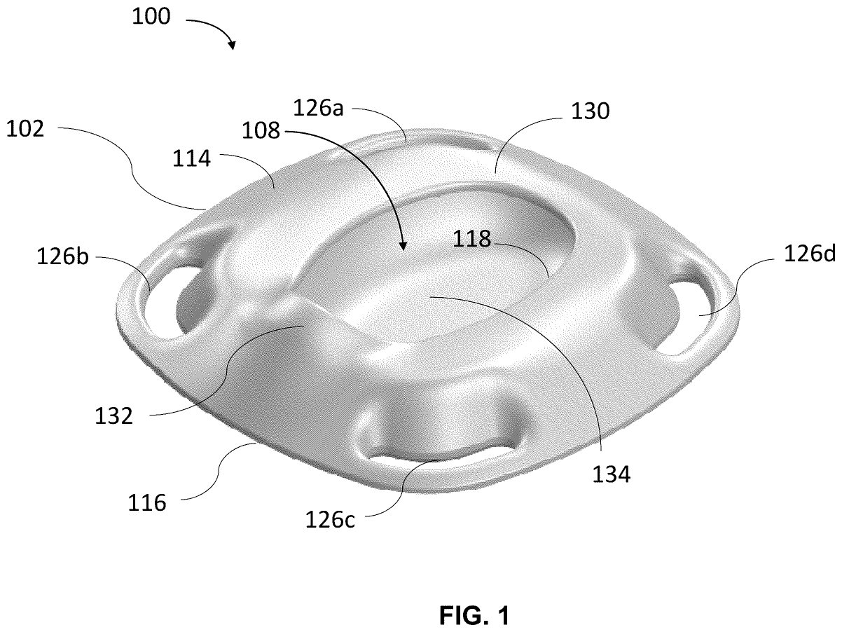

FIGS. 1-5 illustrate certain features that can be included on a first example of a bedpan having angled side surfaces on all sides of the bedpan and having one or more handles formed in the housing (e.g., integrally formed in the housing) on the corners. The illustrated example has a rise portion where a portion of the apron is vertically higher than the rest of the apron. While the first example illustrates that the handles are formed in the housing, it is also contemplated that in some embodiments the bedpan has one or more handle attached to the housing. For example, in a position attached to the housing that is similar to the positions of the handles formed in the housing or attached in another position to the housing. Embodiments of the bedpans can be made as an integral unit, for example, in a molding process. In other embodiments, the bedpan can be fabricated as two or more pieces that are attached together, preferably using a process that creates a sealed chamber in the interior of the bedpan, with the only opening to the chamber being on a proximal surface (that is, a top surface of the bedpan when it is in an operable orientation).

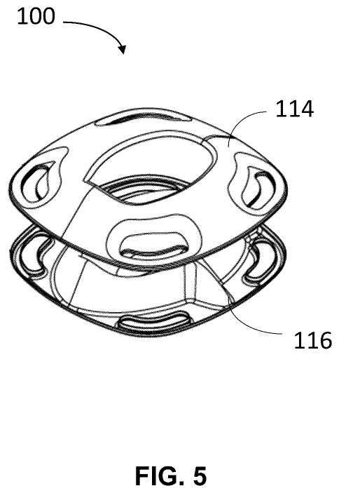

Some examples of bedpans that can be fabricated as two pieces (a top portion and a bottom portion) are illustrated in FIG. 5. In some embodiments, the top portion and the bottom portion can be formed as connected pieces that assemble in a clamshell manner. For ease of reference, the reference to “top” or “proximate” refers to a top portion or surface of the bedpan when it is oriented in a position of normal use as a bedpan (generally facing upward), and “bottom” or “distal” refers to the opposite side (lower or bottom) of the bedpan (generally facing downward). The various embodiments of bedpans include a proximal side indicating the structure or surface faces towards a portion of patient when in use. That is, generally oriented “up” when in use. The various embodiments of bedpans also include a distal side indicating the structure or surface faces away from a portion of patient when in use. That is, generally oriented “down” when in use.

Referring again to FIG. 1, the bedpan 100 includes a housing 102 having a top portion 114 and a bottom portion 116. In the various embodiments described herein, the top portion 114 generally refers to a portion of the bedpan that is positioned closest to the patient and/or in contact with the patient when the bedpan is being used, and the bottom portion 116 of a bedpan refers to a portion of the bedpan that is facing away from the patient and/or in contact with a bed, or another surface that supports the bedpan, when the bedpan is being used. The housing 102 is a low-profile housing having a low height. In some examples, the height is 2″. In some examples, the height is 2″ plus or minus ¾″. In various embodiments, the height can be from ¾″ to about 5″. The height of a bedpan used may depend in part on the patient it is being used for to make it easier to place underneath a patient and how much material the bedpan needs to hold.

In some embodiments, the bedpan can include a rise portion 132 that is vertically higher than the rest of the the apron 130. Advantageously, the rise portion 132 can reduce spillage from the bedpan. In some embodiments, the rise portion 132 can capture material from the patient that may otherwise miss the bedpan. The height of the rise portion 132 may depend in part on the patient it is being used for to ensure the bedpan captures material without spillage. The rise portion 132 can be a part of the top portion 114. The rise portion 132 can be a part of the bottom portion 116. The rise portion 132 can be a part of the top portion 114 and the bottom portion 116.

The bottom portion 116 can include a distal surface and a wall extending from the distal surface to the distal edge. The distal edge can have a bevel on at least a portion of the distal edge which can eliminate a sharp edge on the bedpan. The bevel can include a distal portion of the wall and a proximal portion of the wall. The top portion 114 includes a wall extending from the distal edge to a proximal surface. The proximal edge can have a bevel on at least a proximal portion of the wall and a portion of the proximal surface, which can eliminate a sharp edge on the bedpan 100. The wall is angled inward from the distal edge to the proximal edge, the slope of the wall facilitating positioning the bedpan underneath a patient in an operable position. In the illustrated embodiment, the wall is angled inward on all sides of the bedpan, which allows the bedpan 100 to be placed under a patient in any orientation (i.e., direction). In some embodiments, the bedpan 100 can be configured to have a wall angled inward on less than all sides of the bedpan 100, although this may somewhat limit the direction that the bedpan 100 can be placed under the patient.

The housing 102 can include an opening 108 through the proximal surface which provides a passageway to a chamber floor 134 of the bottom portion 116. The opening 108 can be ovoid having a length L and a width W that correspond to the largest and smallest diameters of the opening 108. In other embodiments, the opening can be differently shaped (e.g., square, circular, oval, etc.). A circumferential edge may surround the opening 108. The housing 102 can include a bevel between the circumferential edge and the proximal surface to eliminate a sharp edge around the opening 108. An apron 130 surrounds the opening 108, and is between the opening 108 and the proximal edge. The apron 130 is generally planar and provides a contact surface for the patient to rest their weight on. The apron 130 includes an edge 118 around the opening 108. The width of the apron 130 (between the opening 108 and the wall) can be, for example, between ½″ and 4″, and is preferably between 1″ to 3″. The chamber floor 134 extends underneath at least a portion of the apron 130 such that the apron 130 provides splash protection for fluids and solid material in the chamber. The rise portion 132 can include a portion of the edge 118. The edge 118 can be straight at the rise portion 132. The edge 118 can be round at the rise portion 132. The edge 118 at the rise portion 132 can be vertically higher than the rest of the edge 118.

The housing 102 can be rectangular-shaped and have four lateral sides. In other embodiments, the housing can have other shapes. For example, the housing 102 can include three sides, four sides, or five sides. In some embodiments, the housing 102 can have more than five sides. In the illustrated embodiment, the housing has four corners that are rounded.

The housing 102 also includes a least one handle 126. In the illustrated example, the housing 102 includes a first handle 126a, a second handle 126b, a third handle 126c, and a fourth handle 126d. Each handle 126 is disposed in a corner of the housing 102. Each handle 126 includes an opening, or a recess in the housing 102. In this example, the opening extends through the housing 102. Each handle 126 also can include a wall facing the opening, and includes a pull member that is configured for a user to engage with fingers to pull, or push, the bedpan under a patient or to remove the bedpan from underneath a patient. In some embodiments, each handle 126 includes an aperture having a longitudinal axis. In some embodiments, the handles on one side have a first longitudinal axis and the handles on the other side have a second longitudinal axis. In some embodiments, the first longitudinal axis is aligned with the second longitudinal axis.

Because of the unique structure of the low-profile bedpan 100, when the bedpan 100 is in use a significant portion of the proximal surface may be in direct contact with a patient's skin.

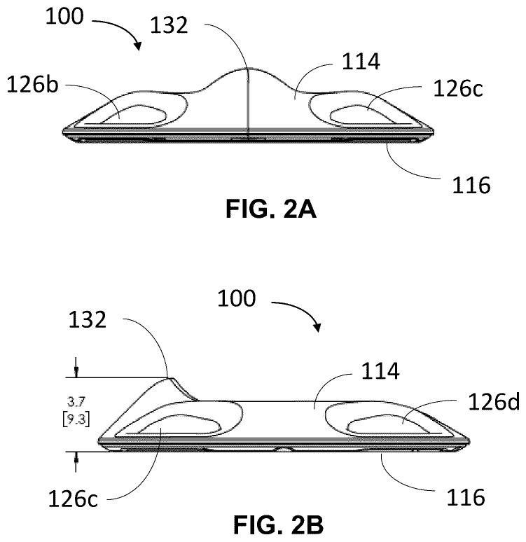

FIGS. 2A and 2B are side perspective views illustrating the first example of the bedpan, illustrating various structural and functional aspects of some embodiments. In some examples, the height of the rise portion 132 (from the bottom of the bedpan) is 3.7″ plus or minus 0.7″. In various embodiments, the height of the rise portion 132 can be from 1″ to about 6″.

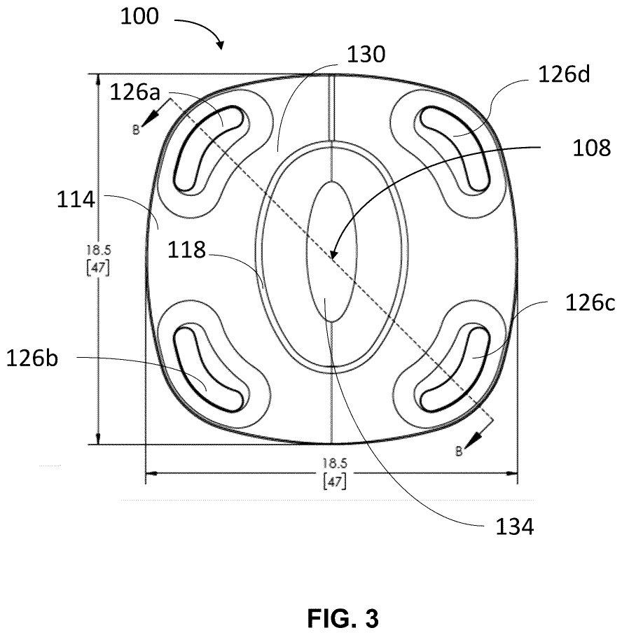

FIG. 3 is a top perspective view illustrating the first example of the bedpan, illustrating various structural and functional aspects of some embodiments. In some examples that bedpan 100 can have a length and width of 18.5″ plus or minus 1″. In various embodiments, the length and width of the bedpan 100 can be from 10″ to 25″

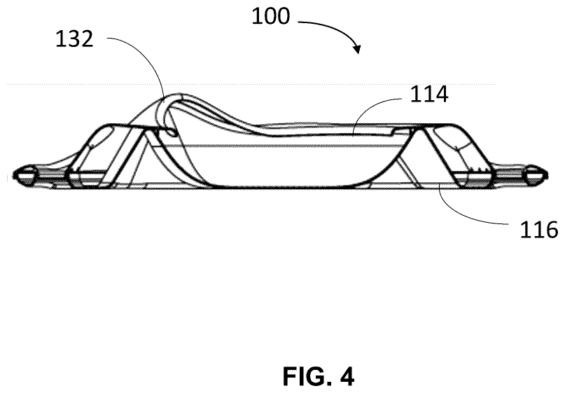

FIG. 4 is a side perspective view illustrating the first example of the bedpan, illustrating various structural and functional aspects of some embodiments.

FIG. 5 is an exploded view illustrating the first example of the bedpan, illustrating various structural and functional aspects of some embodiments, such as the top and bottom portions separated. In some embodiments, the top portion 114 and bottom portion 116 can fit together to form the housing 102. In some embodiments, the top portion 114 and bottom portion 116 can be hingeably connected (not shown in FIG. 5). In some embodiments, the top portion 114 and bottom portion 116 can be completely separable, as illustrated in FIG. 5.

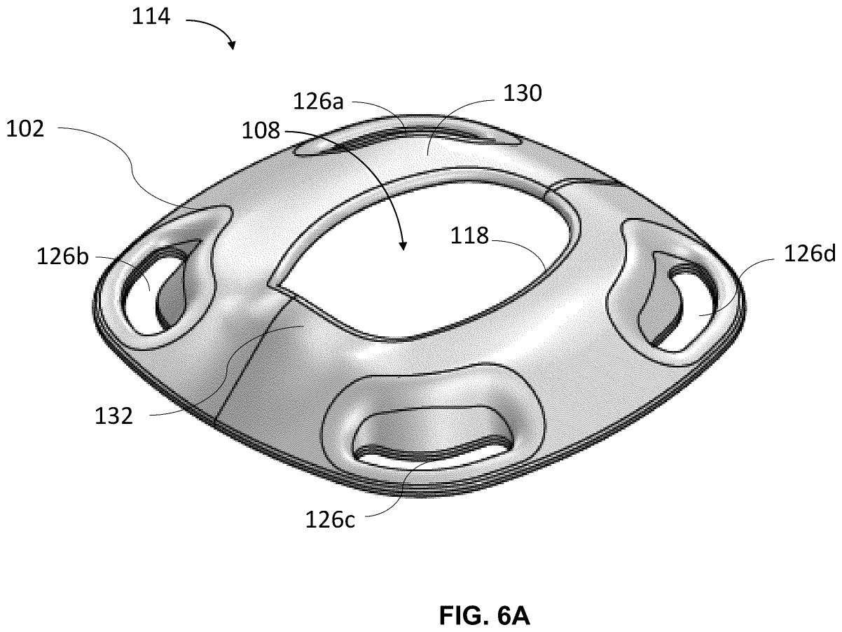

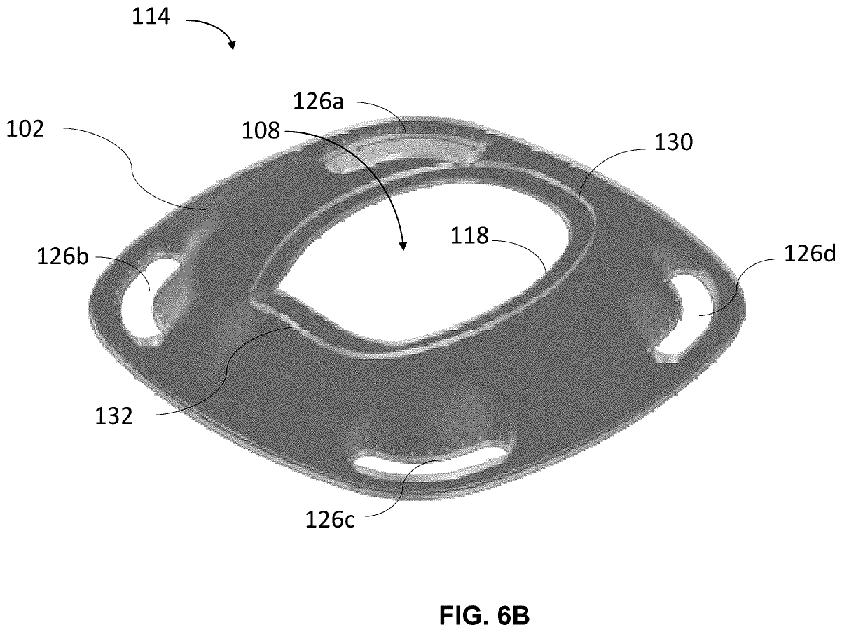

FIGS. 6A and 6B are top, angled perspective views illustrating a top portion of a first example of a bedpan illustrating various structural and functional aspects of some embodiments. In some embodiments, the top portion 114 can be stacked with other top portions 114 when the bottom portion 116 is not joined. In some embodiments, the top portion 114 is configured to fit with other top portions 114. Advantageously, stacking top portions 114 can make storing multiple bedpans more efficient.

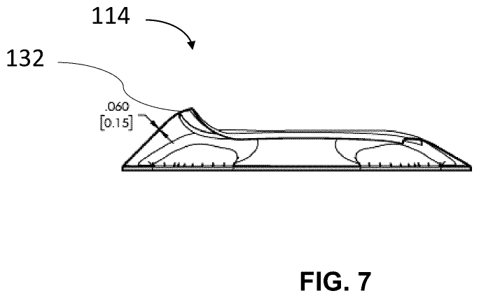

FIG. 7 is a side perspective view illustrating a top portion of a first example of a bedpan illustrating various structural and functional aspects of some embodiments. In some examples, the top portion 114 can have a thickness of 0.6″ plus or minus. 0.2″. In various embodiments, the top portion 114 can have a thickness of 0.2″ to about 1″.

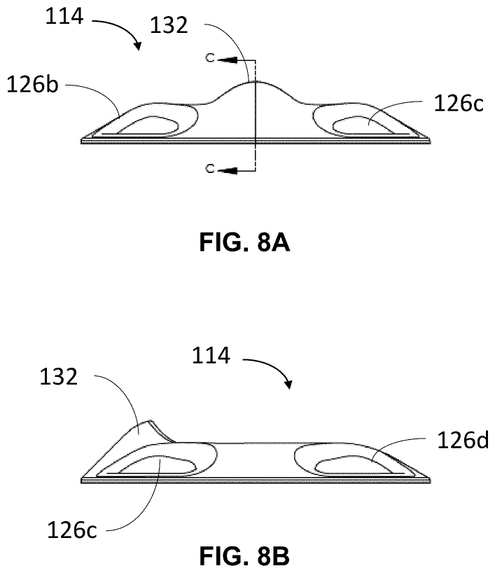

FIGS. 8A and 8B are side perspective views illustrating a top portion of a first example of a bedpan illustrating various structural and functional aspects of some embodiments.

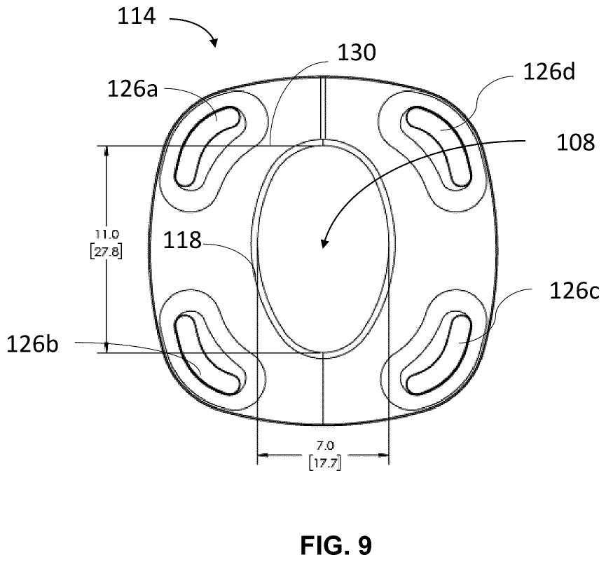

FIG. 9 is a top perspective view illustrating a top portion of a first example of a bedpan illustrating various structural and functional aspects of some embodiments. In some embodiments, the opening 108 has a length of 11″, plus or minus 3″. In some embodiments, the opening 108 has a width of 7″, plus or minus 2″.

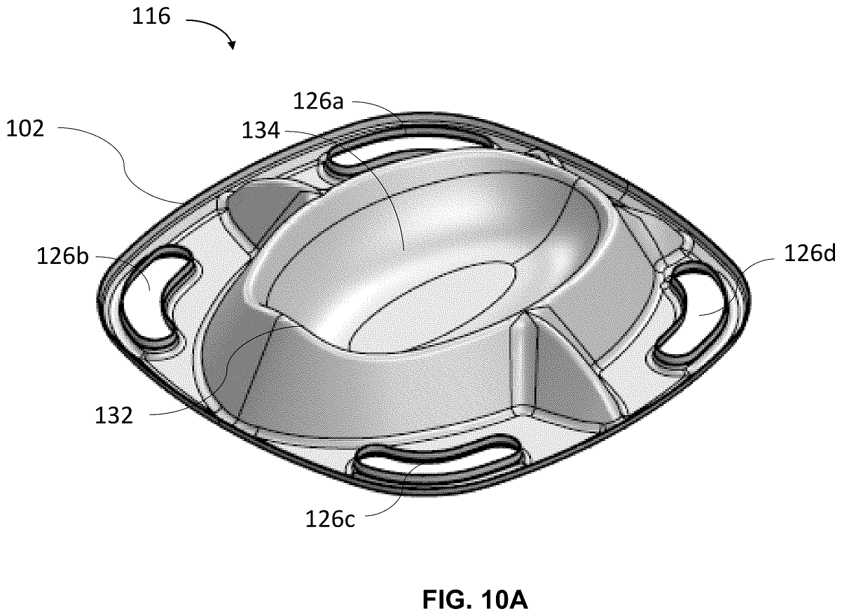

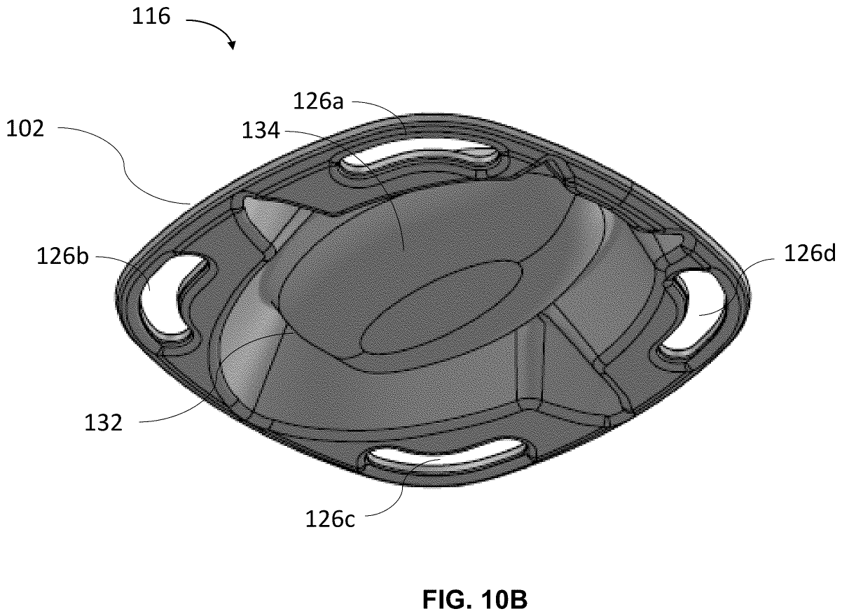

FIGS. 10A and 10B are top, angled perspective views illustrating a bottom portion of a first example of a bedpan illustrating various structural and functional aspects of some embodiments. In some embodiments, the bottom portion 116 can be stacked with other bottom portions 116 when the top portion 114 is not joined. In some embodiments, the bottom portion 116 is configured to fit with other bottom portions 116. Advantageously, stacking bottom portions 116 can make storing multiple bedpans more efficient.

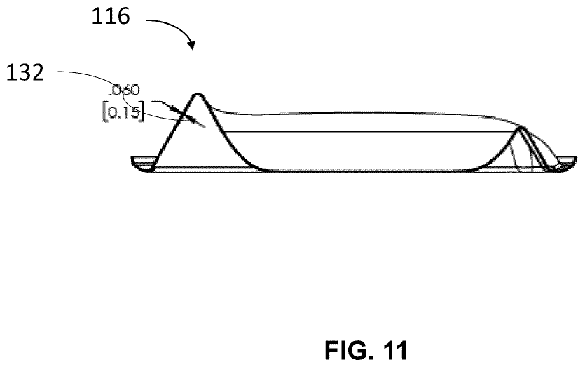

FIG. 11 is a side perspective view illustrating a bottom portion of a first example of a bedpan illustrating various structural and functional aspects of some embodiments.

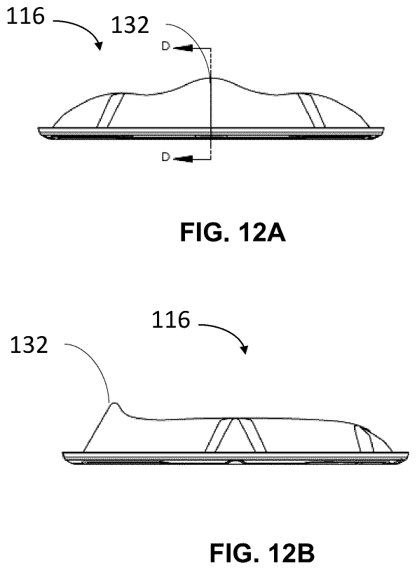

FIGS. 12A and 12B are side perspective views illustrating a bottom portion of a first example of a bedpan illustrating various structural and functional aspects of some embodiments.

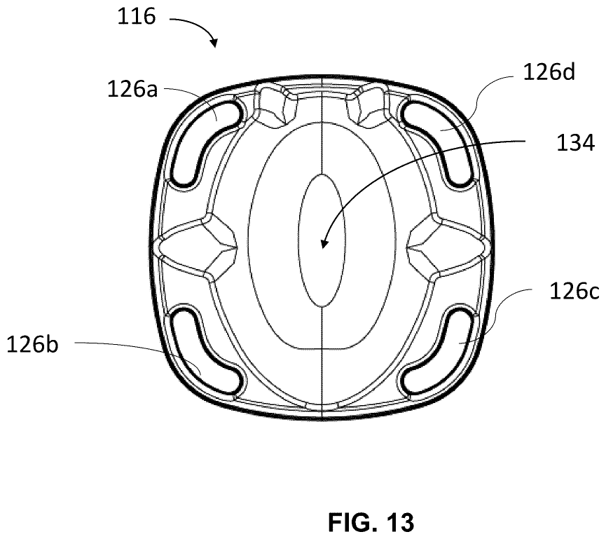

FIG. 13 is a top perspective view illustrating a bottom portion of a first example of a bedpan illustrating various structural and functional aspects of some embodiments. In some examples, the bottom portion 116 can have a thickness of 0.6″ plus or minus 0.2″. In various embodiments, the bottom portion 116 can have a thickness of 0.2″ to about 1″.

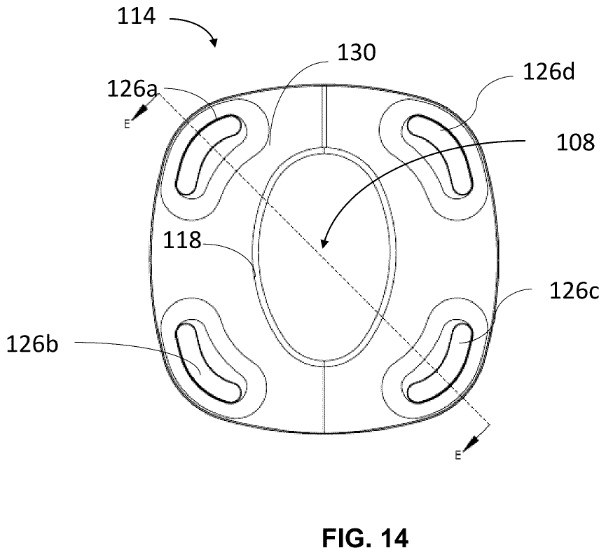

FIG. 14 is a top perspective view illustrating a top portion of a first example of a bedpan illustrating various structural and functional aspects of some embodiments.

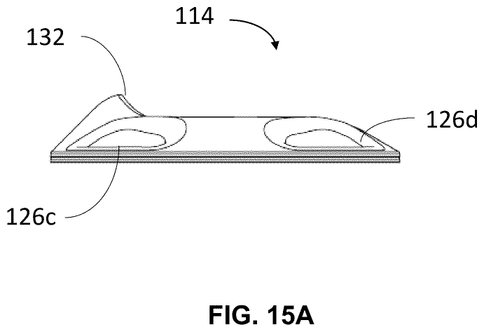

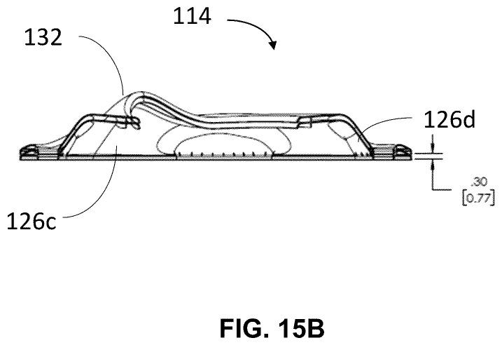

FIGS. 15A and 15B are side perspective views illustrating a top portion of a first example of a bedpan illustrating various structural and functional aspects of some embodiments. In some embodiments, the top portion 114 can have a bottom rim with a thickness of 0.3″ plus or minus 0.2″.

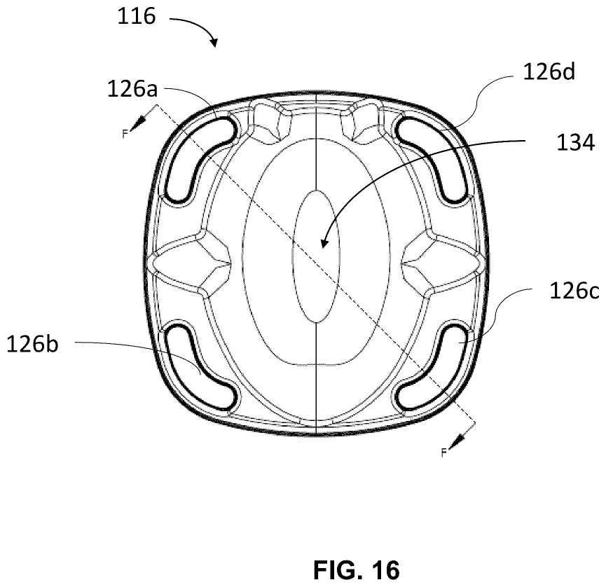

FIG. 16 is a top perspective view illustrating a bottom portion of a first example of a bedpan illustrating various structural and functional aspects of some embodiments.

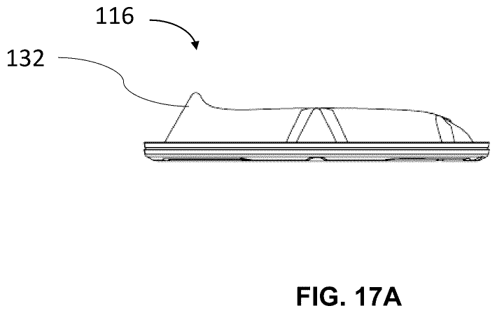

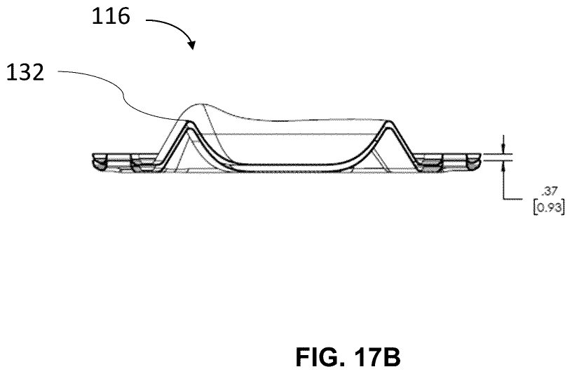

FIGS. 17A and 17B are side perspective views illustrating a bottom portion of a first example of a bedpan illustrating various structural and functional aspects of some embodiments. In some embodiments, the bottom portion 116 can have a bottom rim with a thickness of 0.37″ plus or minus 0.2″.

### Implementation Consideration

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Headings are included herein for reference and to aid in locating various sections. These headings are not intended to limit the scope of the concepts described with respect thereto. Such concepts may have applicability throughout the entire specification.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

It will also be understood that, when a feature or element (for example, a structural feature or element) is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present. Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for case of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/<2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A bedpan comprising:
a housing including
a chamber for holding urine and feces comprising:
a top portion including:
a top surface;
an opening in the top surface, the opening in fluid communication with an interior of the chamber when the top portion and a bottom portion are coupled;
an angled side wall surrounding the top surface; and
a rise portion on the top surface, the rise portion being vertically higher than another portion of the top surface;
the bottom portion including
a bottom surface,
wherein the top portion is configured to be coupled with the bottom portion such that the interior of the chamber is liquid-tight.

2. The bedpan of claim 1, further comprising a handle, wherein the handle is formed integral to the housing.

3. The bedpan of claim 1, further comprising four handles disposed in each of four corners of the housing, the four handles formed integral to the housing.

4. The bedpan of claim 3, wherein a first two handles of the four handles include apertures having a first longitudinal axis, wherein a second two handles of the four handles include apertures having a second longitudinal axis, wherein the first and second axis are aligned, with respect to each other, at an angle A that is 90° plus or minus 30°.

5. The bedpan of claim 3, wherein a first two handles of the four handles are on a first side of the housing and a second two handles of the four handles are on a second side of the housing, and the first side of the housing is adjacent to the second side of the housing.

6. The bedpan of claim 1, further comprising an apron, wherein the apron is sloped downward towards a distal surface as it extends from an edge of a proximal surface to the edge of the opening.

7. The bedpan of claim 1, wherein the opening is generally ovoid in shape.

8. The bedpan of claim 1, wherein the housing further comprises at least one support between an interior surface of the top portion and an interior surface of the bottom portion.

9. The bedpan of claim 8, wherein the housing further comprises a plurality of supports arranged around the chamber.

10. The bedpan of claim 1, wherein the top portion and the bottom portion are operable to be separated.

11. The bedpan of claim 10, wherein the top portion is configured to be stacked on another top portion when the top portion and the bottom portion are separated.

12. The bedpan of claim 10, wherein the bottom portion is configured to be stacked on another bottom portion when the top portion and the bottom portion are separated.
